(19) United States
(12) Patent Application Publication
(10) Pub. No.: US 2023/0339036 A1
(43) Pub. Date: Oct. 26, 2023

(54) POSITIONING ATTACHMENT FOR WELDING TORCH

(71) Applicant: James Bouman, Elm Mott, TX (US)

(72) Inventor: James Bouman, Elm Mott, TX (US)

(21) Appl. No.: 17/727,800

(22) Filed: Apr. 24, 2022

(51) Int. Cl. B23K 5/22

(52) U.S. Cl. CPC B23K 5/22

(57) ABSTRACT

An attachment for a welding torch, comprising: a torch; a body configured to be removable secured to the torch and has a first opening; and an arm, wherein the arm is sized to fit within the first opening and extending from the body towards a location of the torch nozzle and touch a workpiece to define a center point for a cutout.

### BACKGROUND OF THE INVENTION

The present invention relates to an attachment for a welding torch, and more particularly to an attachment for a welding torch that allows for the cutting of a predetermined shape.

Welding is a process that has increasingly become ubiquitous in all industries. While such processes may be automated in certain contexts, a large number of applications continue to exist for manual welding operations, the success of which relies heavily on the proper use of a welding gun or torch. For instance, an improper torch angle can lead to a spatter, improper penetration, and overall poor weldments. However, inexperienced welders often have difficulty establishing the proper torch angle and torch to workpiece distance during welding, and such skills may be somewhat difficult to teach. Furthermore, even experienced welders may have difficulty maintaining these important parameters throughout welding processes.

Certain attachments have been proposed that are used to establish the proper torch to workpiece distance during spot welding. However, these attachments are less than satisfactory in addressing the overall problem, in particular because they do not allow for the movement of the torch along a predefined path to create the proper cutout, and they are limited in scope to spot welding applications, and do not teach proper technique. Therefore, there exists a need for a device that will aid welders or welding trainees in establishing the proper torch angle, torch to workpiece distance, and pattern cutout.

### SUMMARY

Accordingly, it is an objective of the present invention to provide for an attachment for a torch welder to be able to properly position the torch from a surface as well as provide for a device which assists in the cutting of a pattern in the material. These and other objects and advantages of the present invention will be apparent to those of skill in the art from the description which follows.

In a first embodiment, the invention is an attachment for a welding torch, comprising: a body wherein the body has a first opening sized to receive a torch and a second opening; and an arm, wherein the arm is sized to fit within the second opening.

### BRIEF DESCRIPTION OF THE DRAWINGS

FIG. 1 depicts an isometric view of a torch attachment, in accordance with one embodiment of the present invention.

FIG. 2 depicts an isometric view of the torch attachment secured to a torch, in accordance with one embodiment of the present invention.

FIG. 3 depicts an exploded view of the torch attachment, in accordance with one embodiment of the present invention.

### DETAILED DESCRIPTION OF THE INVENTION

The present invention provides a device which attached to a torch to assist the welder in both establishing a position and distance from the surface for the ideal positioning for the torch to perform the cutout, and also assist the welder in following a pattern to cutout the ideal size opening in the piece.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

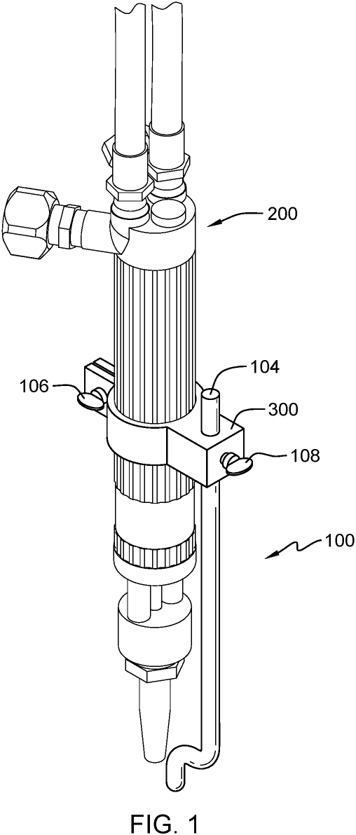

FIG. 1 depicts an isometric view of a torch attachment 100, in accordance with one embodiment of the present invention. The torch attachment 100 is comprised of a holder 300, an arm 104, and set screws 106 and 108. The holder 300 has a main opening 302 which the torch 200 is inserted into or through. The extended portion of the holder 300 has an opening 303 which set screw 106 is used to secure the torch attachment 100 to the torch 200. On the opposite end of the holder 300 is a pair of openings 304 and 305. The arm 104 is sized to fit within the opening 304 and the set screw 108 is sized to fit opening 305. The arm 104 is of a predetermined length and contour to provide a template for the cut which is to be made. In the depicted embodiment, the arm 104 has an extended portion, two bends and a pointed end so that when the arm 104 is placed against the piece of material where the cut is to be made, the arm secures the torch 200 is place, and the welder is able to rotate the torch 200 about the point of contact and complete the cut. The extended portion allowed for the adjustment of the distance the torch 200 is from the material to assist in positioning the torch 200 at the ideal distance for the cut. In the depicted embodiment, the arm 104 is a circular rod, this allows the arm 104 to be rotated within the opening 304 so that a variety of cutout diameters can be made. In other embodiments, the arm 104 may be a square or a predetermined shape to allow only one or a few positions for the arm to be in once inserted into the opening 304 which is of a similar shape to receive the arm 104. The arm 104 may have varying designs with more or fewer bends based on the desired cutout size and shape as well as the proper distance the arm 104 should be from the torch 200.

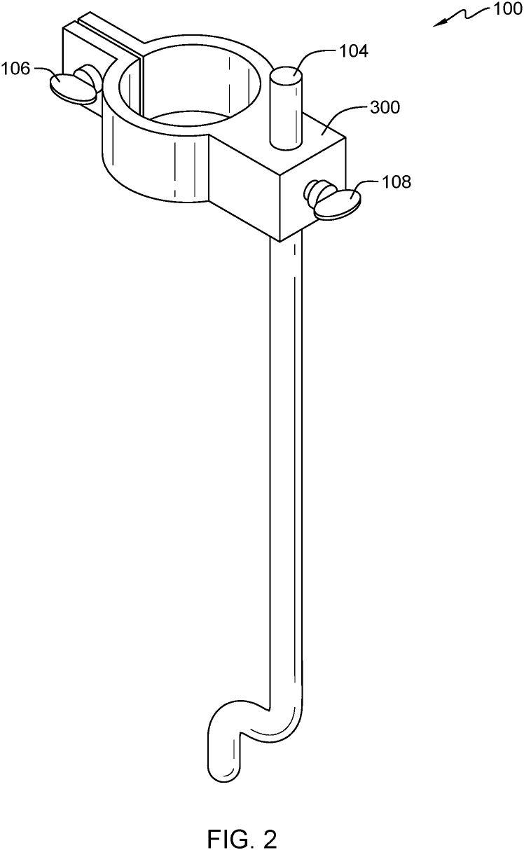

FIG. 2 depicts an isometric view of the torch attachment 100 secured to a torch 200, in accordance with one embodiment of the present invention. The depicted embodiment of the torch attachment 100 holder 300 is an embodiment, with the variety of welding torches on the market the holder 300 may have various designed and shapes to accommodate the different designs of the welding torches. As shown the holder 300 is positioned relatively high away from the torch end 200 so that arm 104 is of an adequate length to extend beyond that portion of the torch 200. The length of the arm 104 and the number of bends are based on the torch 200 to allow for proper placement of the torch 200 from the material and also so that the arm 104 does not interfere with the torch 200 or is damaged during the cutting process. The attachment 100 is designed to be secured to the torch 200 and once locked in place does not move about the torch 200. This is both for safety purposes as well as making sure the cut is as intended.

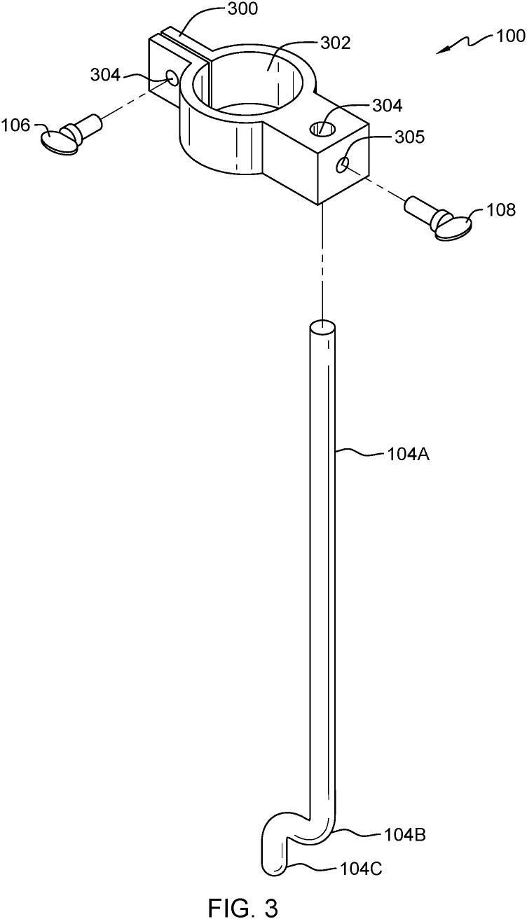

FIG. 3 depicts an exploded view of the torch attachment 100, in accordance with one embodiment of the present invention. As shown in the depicted embodiments, opening 302 is circular to receive the torch which has a circular design (as shown in FIG. 2). In other embodiments, this opening may have various shapes and designs to accommodate one type of torch 200 or various types of torches 200 if the holder 300 is designed to be universal for multiple torch types. The extensions with the opening 303 may be altered and modified to provide different locking mechanisms for the torch attachment 100 based on the design of torch 200. In the depicted embodiment, the set screw 106 is used to pressure fit the holder 300 against the torch 200, by bringing the two extensions together. In the depicted embodiment, arm 104 is shown having a first portion 104A which is designed and sized to provide ample length so that where the attachment 100 attaches to the torch 200, the arm 104 is able to extend beyond the end of the flame. A first bend 104B provides for an offset from where the arm 104 is mounted to the holder 300, which extends to portion 104C. Portion 104C has a dull end in the depicted embodiment to be used to secure the arm 104 in place so it will not move while the cutout is being cut. In various embodiments, the end portion 104C may have a point or other shaped end based on the cutout shape/size, or the torch style/type. The arm 104 may have various bends and shapes depending on the size of the cutout, the shape of the cutout, the torch 200 type and the holder 300 design.

Set screws 106 and 108 are shown an embodiment to secure the rod 104 in the holder 300 and to secure the holder 300 to the torch 200. Various types of locking mechanism can be implemented into the present invention and the set screws with threaded openings are merely one example of a locking mechanism which can be implemented into the present invention. The parts of the attachment are made from a material which is able to withstand the heat of a welder. Various types of steel may be used as well as other materials with high melting points.

The parts of the attachment 100 may be made of a metal, such as brass or steel, which is resistant to the heat generated during welding. In other embodiments, attachment 100 may be made of ceramic. It should be noted that, although the embodiments illustrated in the figures relate generally to metal inert gas (MIG) welding arrangements, the invention may be adaptable to other systems and technologies, such as tungsten inert gas (TIG) torches.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention. While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. An attachment for a welding torch, comprising:
a body wherein the body has a first opening sized to receive a torch and a second opening; and
an arm, wherein the arm is sized to fit within the second opening.

2. The attachment for a welding torch, of claim 1, further comprising a first locking mechanism and a second locking mechanism.

3. The attachment for a welding torch, of claim 2, wherein the second locking mechanism interfaces with the arm.

4. The attachment for a welding torch, of claim 2, wherein the first locking mechanism is integrated into the body distal to the first opening.

5. The attachment for a welding torch, of claim 1, wherein the second opening and the arm are of substantially similar shapes.

6. The attachment for a welding torch, of claim 1, wherein the arm is able to rotate within the second opening.

7. The attachment for a welding torch, of claim 1, wherein the arm has a first portion and a second portion, wherein the second portion is of a predetermined contour based on an intended cutting pattern.

8. The attachment for a welding torch, of claim 1, wherein the arm is made from a material resistant to heat developed during a welding operation.

9. An attachment for a welding torch, comprising:
a torch;
a body configured to be removable secured to the torch and has a first opening; and
an arm, wherein the arm is sized to fit within the first opening and extending from the body towards a location of the torch nozzle and touch a workpiece to define a center point for a cutout.

10. The attachment for a welding torch, of claim 9, wherein the arm is of a predetermined size based on the torch.

11. The attachment for a welding torch, of claim 9, wherein the arm is made from a material resistant to heat developed during a welding operation.

12. The attachment for a welding torch, of claim 9, wherein the arm has a predetermined shape based on a predetermined cutout pattern.

13. An attachment for a welding torch, comprising:
a body configured to be removable secured to a torch; and
an adjustable arm attached to the body, wherein the arm extending from the body towards a location of a torch nozzle and touches a workpiece to define a center point for a cutout.
